(19) United States
(12) Patent Application Publication
(10) Pub. No.: US 2010/0044420 A1
(43) Pub. Date: Feb. 25, 2010

(54) CARTON WITH INSERT

(76) Inventors: Kirsten Laura Brand, Marietta, GA (US); Leonard Cooper, Powder Springs, GA (US); Graham Hand, Marietta, GA (US); Michael Cerio, Kennesaw, GA (US)

Correspondence Address: WOMBLE CARLYLE SANDRIDGE & RICE, PLLC, ATTN: PATENT DOCKETING, P.O. BOX 7037, ATLANTA, GA, 30357-0037, US

(21) Appl. No.: 12/542,871

(22) Filed: Aug. 18, 2009

Related U.S. Application Data
(60) Provisional application No. 61/189,743, filed on Aug. 22, 2008.

(51) Int. Cl. B65D 5/46; B65D 43/00; B65D 43/16; B31B 17/00

(52) U.S. Cl. 229/117.13; 229/124; 229/123.2; 493/84; 493/86; 493/88

(57) ABSTRACT

A carton for containing a plurality of articles. The carton has panels that extend at least partially around an interior of the carton. The panels comprise a top panel, a bottom panel, a first side panel, and a second side panel. At least two end flaps are respectively foldably attached to respective panels of the plurality of panels, wherein the end flaps are overlapped with respect to one another and thereby at least partially form a closed end of the carton. The carton includes a handle in the closed end of the carton for grasping and carrying the carton. The carton comprises a reinforcing insert attached to at least one of the panels for reinforcing the handle.

### CROSS-REFERENCE TO RELATED APPLICATIONS

The present application claims the benefit of Provisional Application No. 61/189,743, filed Aug. 22, 2008, the entire contents of which are hereby incorporated by reference.

### BACKGROUND OF THE DISCLOSURE

The present disclosure generally relates to cartons for holding and dispensing beverage containers or other types of articles. More specifically, the present disclosure relates to cartons having a reinforcing insert.

### SUMMARY OF THE DISCLOSURE

In general, one aspect of the disclosure is directed to a carton for holding a plurality of containers. The carton comprises a plurality of panels that extends at least partially around an interior of the carton. The plurality of panels comprises a top panel, a bottom panel, a first side panel, and a second side panel. At least two end flaps are respectively foldably attached to respective panels of the plurality of panels. The end flaps are overlapped with respect to one another and thereby at least partially form a closed end of the carton. The at least two end flaps comprise a top end flap foldably connected to the top panel. A reinforcing insert comprises a central panel and a reinforcing end flap foldably connected to the central panel. The central panel is in face-to-face contact with the top panel and the reinforcing end flap is in face-to-face contact with the top end flap. A dispenser allows access to the articles in the carton. The dispenser comprises at least a portion of the top panel and at least a portion of the central panel.

In another aspect, the disclosure is generally directed to the combination of a carton blank and an insert blank for forming a carton having reinforced features. The carton blank comprises a plurality of panels comprising a top panel, a bottom panel, a first side panel, and a second side panel. At least two end flaps are respectively foldably attached to respective panels of the plurality of panels for overlapping to at least partially close an end of a carton formed from the carton blank. The at least two end flaps comprise a top end flap foldably connected to the top panel. The insert blank comprises a central panel and a reinforcing end flap foldably connected to the central panel. The central panel is in face-to-face contact with the top panel and the reinforcing end flap is in face-to-face contact with the top end flap. Dispenser features comprise at least a portion of the top panel and at least a portion of the central panel.

In another aspect the disclosure is generally directed to a method of forming a carton. The method comprises obtaining a carton blank, obtaining an insert blank, positioning the insert blank relative to the carton blank, attaching the insert blank to the carton blank, and forming the attached insert blank and carton blank into a carton. The carton blank comprises a plurality of panels comprising a top panel, a bottom panel, a first side panel, and a second side panel. At least two end flaps are respectively foldably attached to respective panels of the plurality of panels. The at least two end flaps comprise a top end flap foldably connected to the top panel. A dispenser feature comprises at least a portion of the top panel. The insert blank comprises a central panel and a reinforcing end flap foldably connected to the central panel. The dispenser feature comprises at least a portion of the central panel. The central panel overlaps at least a portion of the top panel and the reinforcing flap overlaps at least a portion of the top end flap when the insert blank is positioned relative to the carton blank.

Those skilled in the art will appreciate the above stated advantages and other advantages and benefits of various additional embodiments reading the following detailed description of the embodiments with reference to the below-listed drawing figures.

According to common practice, the various features of the drawings discussed below are not necessarily drawn to scale. Dimensions of various features and elements in the drawings may be expanded or reduced to more clearly illustrate the embodiments of the disclosure.

### BRIEF DESCRIPTION OF THE DRAWINGS

FIG. 1 is an exterior plan view of a carton blank used to form a carton in accordance with one aspect of the disclosure.

FIG. 2 is a plan view of an insert blank used to form a reinforcing insert for the carton.

FIG. 3 is a plan view of the insert blank overlaid on the carton blank.

FIG. 4 is a perspective view showing the carton in a partially assembled configuration.

FIG. 5 is a perspective view showing an interior of the carton in a partially assembled configuration.

FIG. 6 is a perspective view showing the assembled carton.

FIG. 7 is a perspective view of the carton in an opened configuration.

FIG. 8 is a perspective view of the carton in an opened configuration.

Corresponding parts are designated by corresponding reference numbers throughout the drawings.

### DETAILED DESCRIPTION OF THE EXEMPLARY EMBODIMENTS

The present disclosure generally relates to cartons that contain articles such as containers, bottles, cans, etc. The articles can be used for packaging food and beverage products, for example. The articles can be made from materials suitable in composition for packaging the particular food or beverage item, and the materials include, but are not limited to, aluminum and/or other metals; glass; plastics such as PET, LDPE, LLDPE, HDPE, PP, PS, PVC, EVOH, and Nylon; and the like, or any combination thereof.

Cartons according to the present disclosure can accommodate articles of any shape. For the purpose of illustration and not for the purpose of limiting the scope of the disclosure, the following detailed description describes beverage containers (e.g., glass beverage bottles) as disposed within the carton embodiments. In this specification, the terms “lower,” “bottom,” “upper” and “top” indicate orientations determined in relation to fully erected and upright cartons.

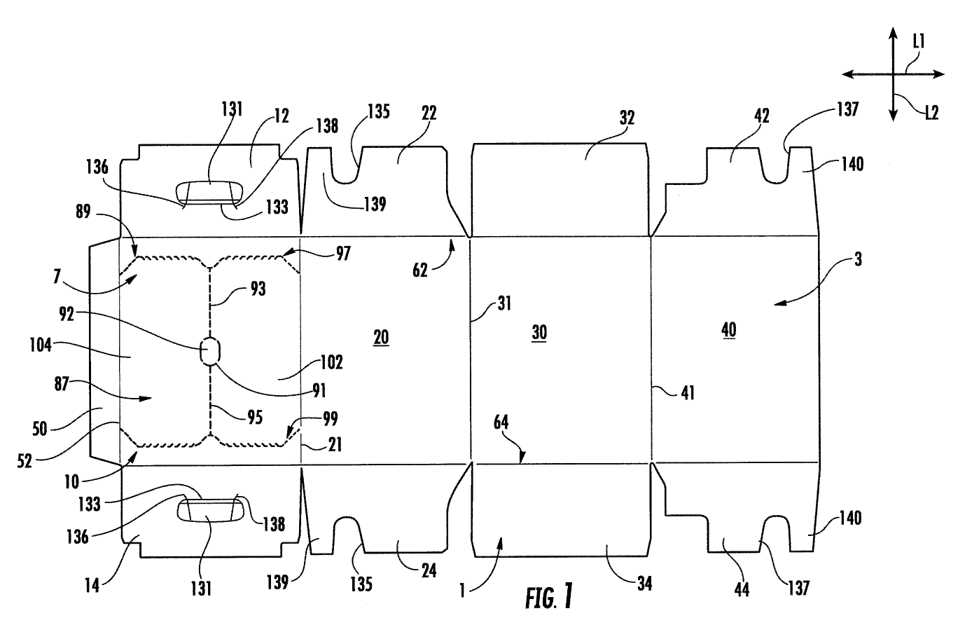

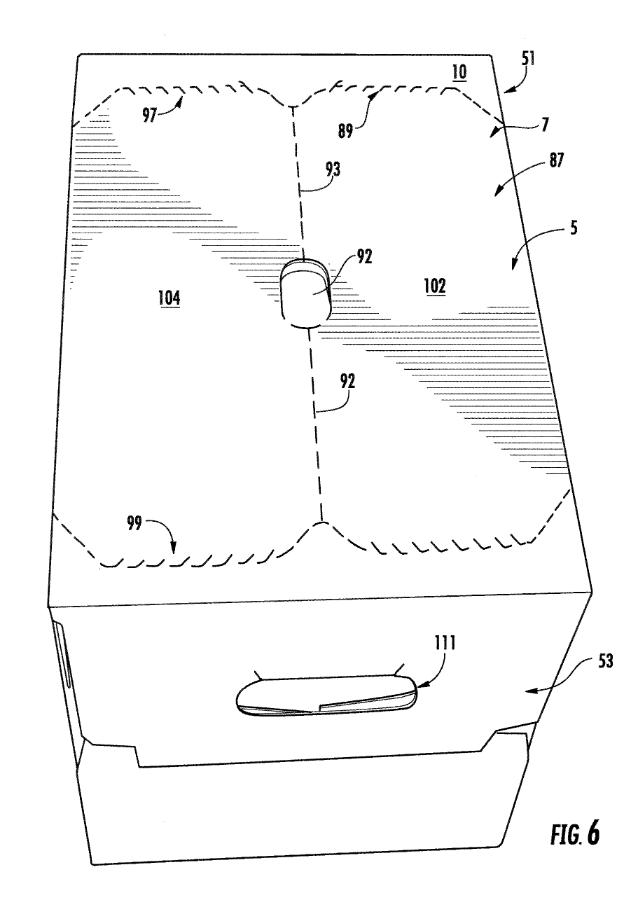

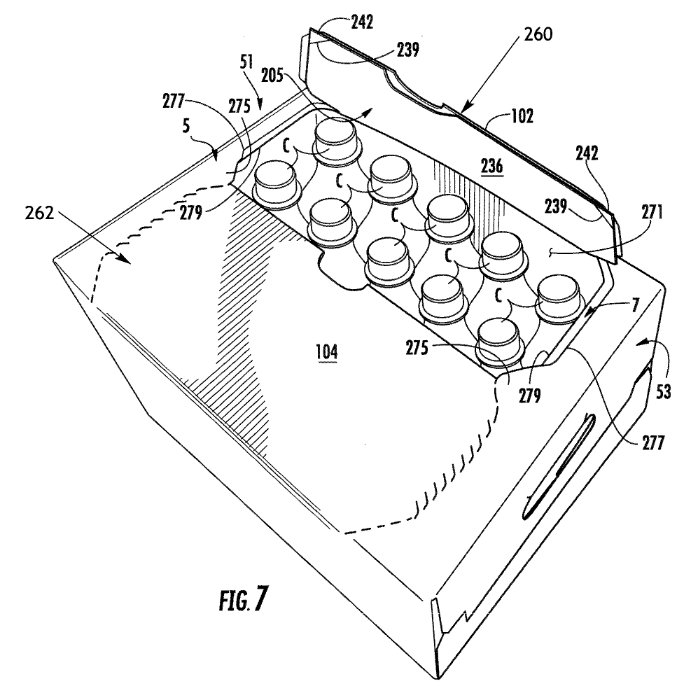

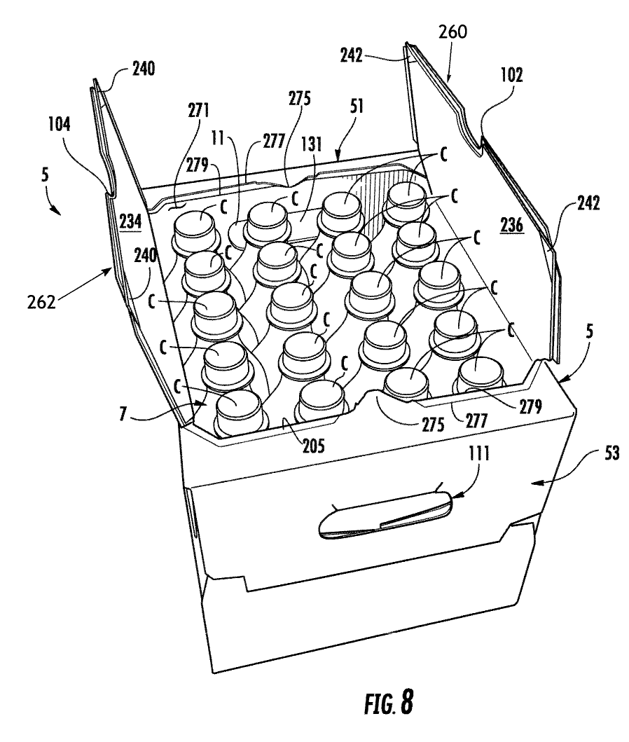

FIG. 1 is a plan view of the exterior side 1 of a blank, generally indicated at 3, used to form a carton 5 (FIGS. 6-8) according to the exemplary embodiment of the disclosure. The carton 5 can be used to house a plurality of articles such as containers C (FIGS. 7 and 8). The carton 5 has a dispenser, generally indicated at 7 (FIGS. 6-8), formed in the carton for allowing access to the containers C. In the illustrated embodiment, the carton 5 is sized to house twenty containers C in a single layer in a 4×5 arrangement, but it is understood that the carton 5 may be sized and shaped to hold containers of a different or same quantity in more than one layer and/or in different row/column arrangements (e.g., 1×6, 3×6, 2×6×2, 3×4, 3×5, 2×9, 2×6, 3×4, etc.). In the illustrated embodiment, the carton 5 includes a first handle, generally indicated at 11 for grasping and carrying the carton at a first end 51 of the carton, and a second handle, generally indicated at 111, for grasping and carrying the carton at a second end 53 of the carton (FIG. 8). As will be discussed below in more detail, the handles 11, 111 are formed from various features in the blank 3.

The carton blank 3 has a longitudinal axis L1 and a lateral axis L2. In the illustrated embodiment, the blank 3 comprises a top panel 10 foldably connected to a first side panel 20 at a first lateral fold line 21. A bottom panel 30 is foldably connected to the first side panel 20 at a second lateral fold line 31. A second side panel 40 is foldably connected to the bottom panel 30 at a third lateral fold line 41. In the illustrated embodiment, the blank 3 includes an adhesive flap 50 foldably connected to the top panel 10 at a fourth lateral fold line 52.

The top panel 10 is foldably connected to a first top end flap 12 and a second top end flap 14. The first side panel 20 is foldably connected to a first side end flap 22 and a second side end flap 24. The bottom panel 30 is foldably connected to a first bottom end flap 32 and a second bottom end flap 34. The second side panel 40 is foldably connected to a first side end flap 42 and a second side end flap 44. When the carton 5 is erected, the top and bottom end flaps 12 and 32 and side end flaps 22 and 42 close a first end 51 of the carton, and the top and bottom end flaps 14 and 34 and side end flaps 24 and 44 close a second end 53 of the carton (FIG. 6). In accordance with an alternative embodiment of the present disclosure, different flap arrangements can be used for at least partially closing the ends 51, 53 of the carton 5.

The top and bottom end flaps 12 and 32 and side end flaps 22 and 42 extend along a first marginal area of the blank 3, and are foldably connected at a first longitudinal fold line 62 that extends along the length of the blank. The top and bottom end flaps 14 and 34 and side end flaps 24 and 44 extend along a second marginal area of the blank 3, and are foldably connected at a second longitudinal fold line 64 that also extends along the length of the blank. The longitudinal fold lines 62, 64 may be, for example, substantially straight, or offset at one or more locations to account for blank thickness or for other factors.

The dispenser 7 includes a dispenser panel 87 formed in the top panel 10. The dispenser panel 87 is separable from the carton 5 along a tear line, generally indicated at 89, to form a dispenser opening 271 (FIG. 8) in the carton. The dispenser 7 can include a finger panel 92 in the top panel 10 that is separable from the carton at an oval-shaped tear line 91 for example. In the illustrated embodiment, the tear line 89 includes a first portion 93 in the top panel 10 that extends in the lateral direction L2 from one side of the finger panel 92 and a second portion 95 that extends in the lateral direction from the opposite side of the finger panel. The tear line 89 has a third portion 97 that extends across the width of the top panel 10 between the fold lines 21, 52, and a fourth portion 99 that extends across the width of the top panel between the fold lines 21, 52. In the illustrated embodiments, the third and fourth portions 97, 99 of the tear line 89 intersect with a respective first and second portion 93, 95 of the tear line. As shown in FIG. 1, the third and fourth portions 97, 99 of the tear line 89 include portions extending in the longitudinal direction L1, portions that are oblique relative to the longitudinal axis L1, and curved portions. The third and fourth portions 97, 99, or other portions, of the tear line can be otherwise shaped, arranged, and positioned without departing from the scope of this disclosure. In the illustrated embodiment, the first portion 93 and third portion 97 of the tear line 89 intersect to form a first generally T-shaped tear line, and the second portion 95 and fourth portion 99 intersect to form a second generally T-shaped tear line.

In the illustrated embodiment the tear line 89 divides the dispenser panel 87 into a first portion 102 and a second portion 104. The first and second portions 102, 104 of the dispenser panel 87 are opened by tearing the tear line 89, upwardly folding the first portion 102 about a portion of the lateral fold line 21 and upwardly folding the second portion 104 about a portion of the lateral fold line 52. The dispenser 7 may be otherwise sized, shaped, and/or located in the carton 5 without departing from the scope of this disclosure. For example, third and forth portions might extend only partially across the top panel 10, wherein one or both of the portions 102, 104 are connected to the top panel 10 at fold lines in the top panel 10 that are not collinear with the fold lines 21, 52. Further, the dispenser 7 may be omitted from the carton 5 without departing from the scope of the disclosure.

As shown in FIG. 1, the features that form the first handle 11 of the carton 5 include an elongate handle flap 131 formed in the top panel end flap 12 and foldably attached to the top panel end flap at a handle fold line 133. In the illustrated embodiment, the features of handle 11 include two oblique cut lines 136, 138 extending from the fold line 133. The features of the handle 11 include respective curved cutouts 135, 137 below the respective upper portions 139, 140 in the end flaps 22, 42 that allow the elongate handle flap 131 to fold inwardly when the handle is activated to form a handle opening in the carton. The elongate handle flap 131 is shaped and positioned in the blank 3 so that the handle 11 is activated by pressing on the handle flap and folding the handle flap inward into the curved cutouts 135, 137 below the respective upper portions 139, 140 to form the handle opening in the carton 5. The opening is shaped for insertion of a users fingers during grasping of the carton 5. The handle 11 may be otherwise shaped and located in the carton 5 without departing from the scope of this disclosure.

In the illustrated embodiment, the second handle 111 is formed from features that are substantially similar to the features that form the first handle 11. The second handle 111 could have different features than the first handle without departing from the disclosure. Further, the second handle 111 can be omitted without departing from the disclosure.

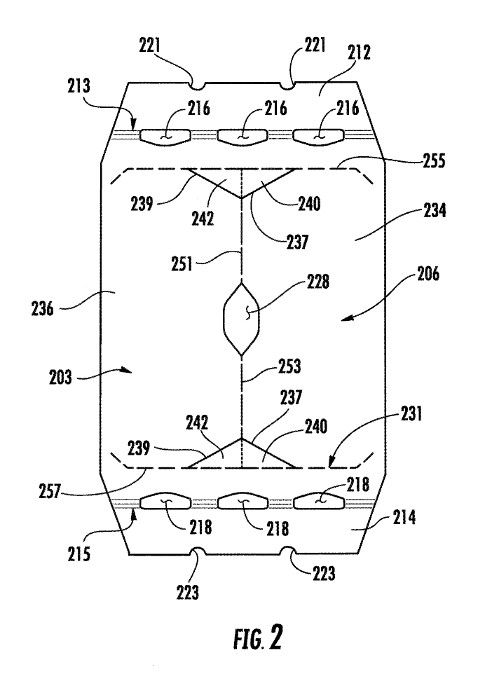

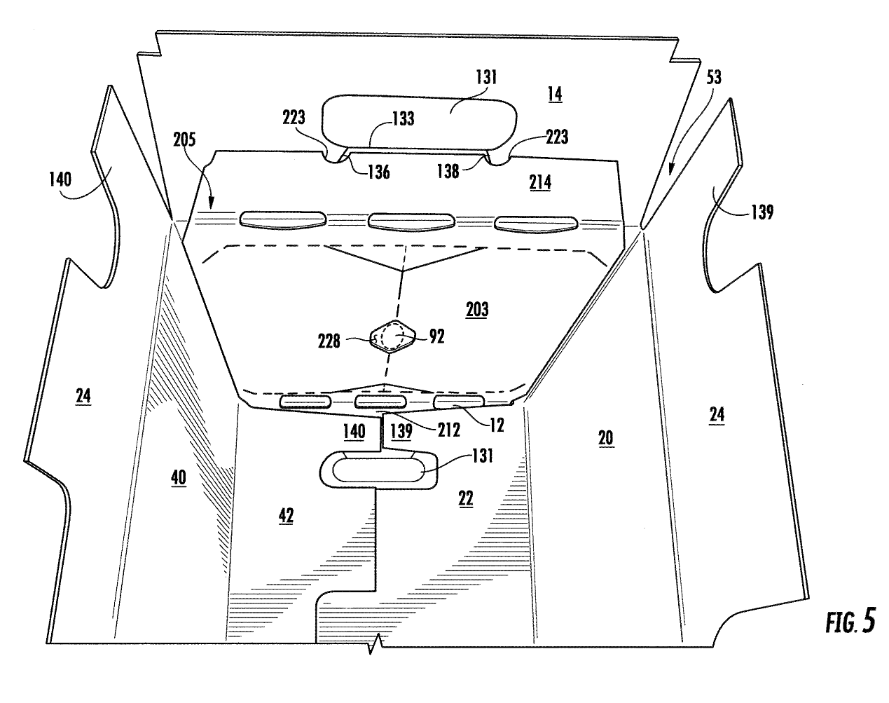

FIG. 2 illustrates an insert blank 203 used to form a reinforcing insert 205 (FIG. 5) for use in the carton 5. In the illustrated embodiment, the insert blank 203 includes a central panel 206 and two end flaps 212, 214 respectively foldably connected to the central panel 206 at opposite ends of the central panel. A first area of weakening 213 connects the first end flap 212 at the first end of the insert blank 203. A second area of weakening 215 connects the second end flap 214 at the second end of the insert blank 203. In the illustrated embodiment, the areas of weakening 213, 215 each comprise three parallel fold lines that extend between three elongate openings 216, 218. Each end flap 212, 214 is respectively, independently foldable relative to the central panel 206 at respective areas of weakening 213, 215. The areas of weakening 213, 215 could be otherwise shaped, arranged, and located (e.g., could comprise a single fold line) without departing from the scope of this disclosure. Each end flap 212, 214 includes two notches 221, 223 at respective end edges of the insert blank 203.

The central panel 206 includes an elongate opening 228 at the center of the central panel. The elongate opening 228 is shaped to be larger than the finger panel 92 in the carton blank 3. A tear line 231 is provided in the central panel 206 that generally corresponds with the tear line 89 of the top panel 10. The central panel 206 is separable at the tear line 231 into a first and second flap 234, 236, respectively. Each flap 234, 236 has two corners or retention portions 240, 242 respectively foldably connected to the flap at a fold line 237, 239 that is oblique relative to the edges of the flap. In the illustrated embodiment, the tear line 231 includes a first portion 251 and a second portion 253 extending from opposite ends of the elongate opening 228. The tear line includes a third portion 255 that is generally perpendicular to the first portion 251 and a fourth portion 257 that is generally perpendicular to the second portion 253. The third portion 255 and the first portion 251 of the tear line 231 form a first generally T-shaped tear line in the insert blank 203 and the fourth portion 257 and the second portion 253 form a second generally T-shaped portion in the insert blank. The tear line 231 and the other features of the insert blank 203 could be otherwise shaped and arranged without departing from this disclosure.

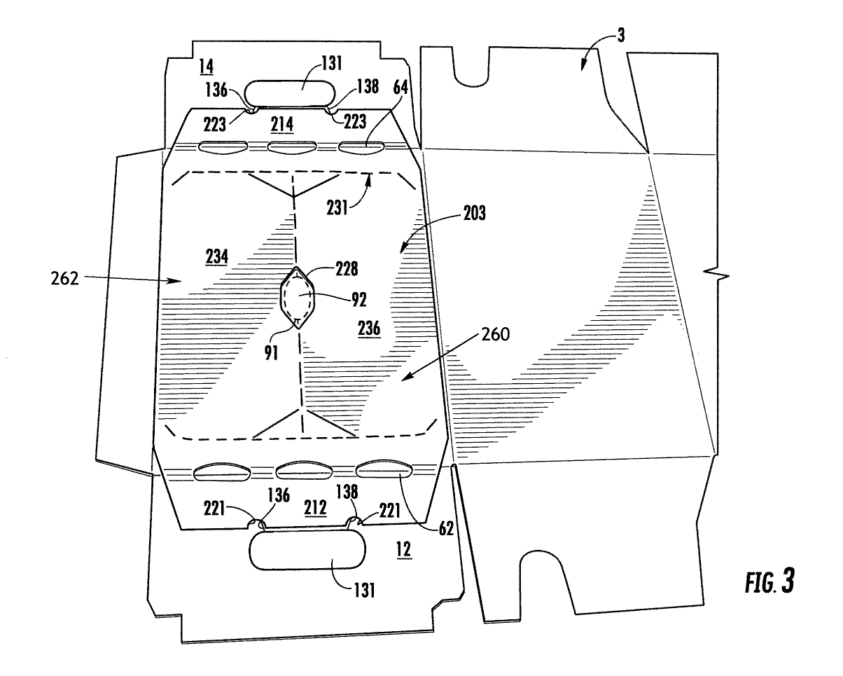

As shown in FIG. 3, the carton 5 is assembled by initially adhering the insert blank 203 to the top panel 10 of the carton blank 3. The insert blank 203 is positioned on the carton blank 3 so that the elongate opening 228 is concentric with the finger panel 92 in the top panel. The areas of weakness 213, 215 generally overlay the longitudinal fold lines 62, 64. The end flaps 212, 214 of the insert blank are in generally face-to-face contact with portions of the end flaps 12, 14 of the carton blank. The notches 221, 223 at respective edges of the end flaps 212, 214 of the insert blank 203 generally frame cuts 136, 138 in the end flaps 12, 14 of the carton blank 3. The tear line 231 of the insert blank 203 is generally positioned to correspond with and overlay the tear line 89 of the carton blank 3. The second and first flap 236, 234 of the insert blank 203 are in generally face-to-face contact with and are adhered to the first and second portions 102, 104 of the dispenser panel 87, forming the first and second dispenser flaps 260, 262.

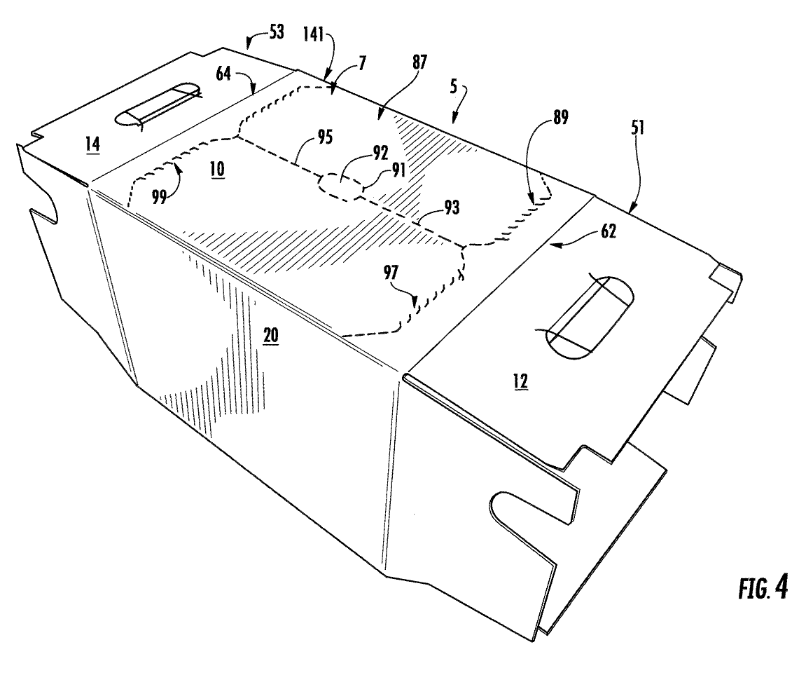

In accordance with the exemplary embodiment, the carton blank 3 with insert blank 203 can be further erected into the carton 5 by folding along fold lines 21, 31, 41, and 52 and adhering the adhesive flap 50 to the second side panel 40 to form a sleeve 141 (FIG. 4). The carton blank 3 may be otherwise configured to have multiple top panels, multiple bottom panels, multiple side panels, or combinations thereof without departing from the scope of this disclosure.

In the illustrated embodiment, the first end 51 of the carton 5 is closed by respectively overlapping and adhering the side end flaps 22, 42 and the top and bottom end flaps 12, 32. The second end 53 of the carton 5 is closed by respectively overlapping and adhering the side end flaps 24, 44 and top and bottom end flaps 14, 34. The top end flaps 12, 14, the upper portions 139, 140, and the reinforcing end flaps 212, 214 provide three layers of material above each handle 11, 111 with the reinforcing flaps 212, 214 in face-to-face contact with an interior surface of the respective top end flaps 12, 14, and in face-to-face contact with an exterior surface of the respective side end flaps 22, 42 and side end flaps 24, 44. Once the blank 3 is formed into the sleeve 141, the containers C may be loaded in the carton 5 from the first end 51 and then the first end may be closed by overlapping and gluing the side end flaps 22, 42 and top and bottom end flaps 12, 32, and then the second end may be closed by overlapping and gluing the side end flaps 24, 44 and top and bottom end flaps 14, 34. The assembled carton 5 is shown in FIG. 6. Alternative assembling, loading, and closing steps may be used without departing from the scope of this disclosure.

The handle 11 can be used to grasp the carton 5 by pressing against the elongate handle flap 131 to create a handle opening in the closed first end 51 of the carton 5. Similarly, the handle 111 can be used to grasp the carton 5 at the closed second end 53. The end flaps 212, 214 of the reinforcing insert provide an extra layer of material above each handle 11, 111 to reinforce the carton 5 by increasing the strength and rigidity of the carton to prevent tearing or other failure when the carton is lifted at the handles. It is understood that the carton 5 may have one handle or no handles or that the handles 11, 111 can be otherwise shaped, arranged, and/or located without departing from the disclosure. In the illustrated embodiment, when the carton 5 is closed and the handle 11 activated for grasping of the carton (FIG. 7), the handle flap 131 can be folded inward along fold line 133 to be in opposing face-to-face relation with the interior surface of the upper portions 139, 140 of the respective side panel end flaps 22, 42. Other opening arrangements for the handles 11, 111 can be provided.

As shown in FIGS. 6-8, the carton 5 can be opened by actuating the dispenser 7 to create a dispenser opening 271 in the top panel 10 of the carton. The dispenser 7 is opened by first removing the finger panel 92 by pressing and tearing the carton at tear line 91. As shown in FIG. 7, the dispenser 7 is further opened by tearing along tear line 89 and upwardly folding the first dispenser flap 260. In the illustrated embodiment the first portion 102 is adhered to the second flap 236 of the reinforcement insert 205, wherein the second flap 236 forms an inner layer of material of the dispenser flap 260 and the first portion 102 forms an outer layer of material of the dispenser flap 260. The second portion 104 is adhered to the first flap 234 of the reinforcement insert 205, wherein the first flap 234 forms an inner layer of material of the dispenser flap 262 and the second portion 104 forms an outer layer of material of the dispenser flap 262. As shown in FIGS. 7 and 8, the corners 240, 242 of the first and second flaps 234, 236 extend outward beyond a respective edge of the first and second portion 102, 104 of the dispenser panel 87. The shape of the tear line 89 in the top panel 10 creates two retention tabs 275 at opposite ends of the dispenser opening 271. Fold lines 237, 239 allow the corners 240, 242 to bend with respect to the remainder of the flaps 234, 236 as the corners 240, 242 pass the retention tabs 275. The tear line 89 further forms top edges 277 of the top panel 10 at the opening 271. The tear line 231 forms inner edges 279 of the central panel 206 at the opening 271. Other opening arrangements for the dispenser 7 can be provided.

In the illustrated embodiment, the dispenser panel 87 can be closed by downwardly folding the first and second dispenser flaps 260, 262 so that the corners 240, 242 of the reinforcement insert 205 are placed below the retention tabs 275 to retain the first and second dispenser flaps in the downwardly folded position. Other closing arrangements and retention mechanisms for the dispenser 7 can be provided.

The blanks according to the present disclosure can be, for example, formed from coated paperboard and similar materials. For example, the interior and/or exterior sides of the blanks can be coated with a clay coating. The clay coating may then be printed over with product, advertising, price coding, and other information or images. The blanks may then be coated with a varnish to protect any information printed on the blank. The blanks may also be coated with, for example, a moisture barrier layer, on either or both sides of the blank. In accordance with the above-described embodiments, the blanks may be constructed of paperboard of a caliper such that it is heavier and more rigid than ordinary paper. The blanks can also be constructed of other materials, such as cardboard, hard paper, or any other material having properties suitable for enabling the carton to function at least generally as described herein. The blanks can also be laminated or coated with one or more sheet-like materials at selected panels or panel sections.

In accordance with the above-described embodiments of the present disclosure, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed portion in the material along the desired line of weakness; a cut that extends partially into a material along the desired line of weakness, and/or a series of cuts that extend partially into and/or completely through the material along the desired line of weakness; and various combinations of these features.

As an example, a tear line can include: a slit that extends partially into the material along the desired line of weakness, and/or a series of spaced apart slits that extend partially into and/or completely through the material along the desired line of weakness, or various combinations of these features. As a more specific example, one type tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut line. That is, it is within the scope of the present disclosure for each of the tear lines to be replaced with a continuous slit, or the like. For example, a cut line can be a continuous slit or could be wider than a slit without departing from the present disclosure.

The above embodiments may be described as having one or more panels adhered together by glue during erection of the carton embodiments. The term “glue” is intended to encompass all manner of adhesives commonly used to secure carton panels in place.

The foregoing description of the disclosure illustrates and describes various embodiments. As various changes could be made in the above construction without departing from the scope of the disclosure, it is intended that all matter contained in the above description or shown in the accompanying drawings shall be interpreted as illustrative and not in a limiting sense. Furthermore, the scope of the present disclosure covers various modifications, combinations, alterations, etc., of the above-described embodiments that are within the scope of the claims. Additionally, the disclosure shows and describes only selected embodiments of the disclosure, but the disclosure is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A carton for containing a plurality of articles, the carton comprising:
a plurality of panels that extends at least partially around an interior of the carton, the plurality of panels comprises a top panel, a bottom panel, a first side panel, and a second side panel;
at least two end flaps respectively foldably attached to respective panels of the plurality of panels, wherein the end flaps are overlapped with respect to one another and thereby at least partially form a closed end of the carton, the at least two end flaps comprise a top end flap foldably connected to the top panel;
a reinforcing insert comprising a central panel and a reinforcing end flap foldably connected to the central panel, the central panel is in face-to-face contact with the top panel and the reinforcing end flap is in face-to-face contact with the top end flap;
a dispenser for allowing access to the articles in the carton, the dispenser comprises at least a portion of the top panel and at least a portion of the central panel.

2. The carton of claim 1 wherein the dispenser comprises a first dispenser flap and a second dispenser flap, the first and second dispenser flaps being foldably connected to the top panel.

3. The carton of claim 2 wherein each of the first dispenser flap and the second dispenser flap respectively comprises at least a portion of the top panel and at least a portion of the central panel.

4. The carton of claim 3 wherein the dispenser comprises a first tear line in the top panel and a second tear line in the central panel.

5. The carton of claim 3 wherein the first dispenser flap and the second dispenser flap each comprises an inner and outer layer of material, the inner layer of material of the first and second dispenser flaps comprising at least a portion of the central panel, and the outer layer of material of the first and second dispenser flaps comprising at least a portion of the top panel.

6. The carton of claim 5 wherein the top panel comprises at least one retention tab, the first dispenser flap and the second dispenser flap being positionable between a closed position and an open position allowing access to articles in the container, the at least one retention tab being for retaining the dispenser flaps in the closed position.

7. The carton of claim 6 wherein the at least one retention tab comprises two retention tabs, each retention tab being positioned for retaining at least one of the first dispenser panel and the second dispenser panel.

8. The carton of claim 6 wherein the inner layer of each of the first dispenser flap and the second dispenser flap comprises a retention portion that extends beyond a perimeter of the outer layer of the respective first dispenser flap and the second dispenser flap, each of the retention portions being positioned for engaging the at least one retention tab to retain the respective first and second dispenser flap in the closed position.

9. The carton of claim 1, the carton comprises a handle for grasping and carrying the carton, the handle comprising a handle flap foldably connected to the top end flap, the reinforcing end flap being adjacent to the handle flap.

10. The carton of claim 9 wherein the at least two end flaps comprise a first side end flap foldably connected to the first side panel and a second side end flap foldably connected to the second side panel, the handle comprises a first handle cutout in the first side end flap and a second handle cutout in the second side end flap, wherein the top end flap, the first side end flap, and the second side end flap cooperate to form the closed end of the carton.

11. The carton of claim 10 wherein the handle flap is positioned for being inserted into the first and second handle cutouts when the handle is activated to grasp the carton.

12. The carton of claim 11 wherein the reinforcing end flap is in face-to-face contact with an exterior surface of the side end flaps and is positioned adjacent the first and second handle cutouts.

13. The carton of claim 12 wherein the reinforcing end flap is in face-to-face contact with an interior surface of the top end flap so that the carton comprises three layers of material adjacent the handle, the three layers of material comprising at least a portion of the top end flap, the reinforcing end flap, and the first and second side end flaps.

14. In combination, a carton blank and an insert blank for forming a carton having reinforced features,
the carton blank comprising:
a plurality of panels comprising a top panel, a bottom panel, a first side panel, and a second side panel;
at least two end flaps respectively foldably attached to respective panels of the plurality of panels for overlapping to at least partially close an end of a carton formed from the carton blank, the at least two end flaps comprise a top end flap foldably connected to the top panel;
the insert blank comprising:
a central panel and a reinforcing end flap foldably connected to the central panel, the central panel is in face-to-face contact with the top panel and the reinforcing end flap is in face-to-face contact with the top end flap;
wherein dispenser features comprise at least a portion of the top panel and at least a portion of the central panel.

15. The combination of claim 14 wherein the dispenser features comprise a first dispenser flap and a second dispenser flap, the first and second dispenser flaps being foldably connected to the top panel.

16. The combination of claim 15 wherein each of the first dispenser flap and the second dispenser flap respectively comprises at least a portion of the top panel and at least a portion of the central panel.

17. The combination of claim 16 wherein the dispenser features comprise a first tear line in the top panel and a second tear line in the central panel.

18. The combination of claim 16 wherein the first dispenser flap and the second dispenser flap each comprises an inner and outer layer of material, the inner layer of material of the first and second dispenser flaps comprising at least a portion of the central panel, and the outer layer of material of the first and second dispenser flaps comprising at least a portion of the top panel.

19. The combination of claim 18 wherein the top panel comprises at least one retention tab in the top panel abutting the outer layer of material of at least one of the first and second dispenser flaps, and wherein the inner layer of material of the at least one of the first and second dispenser flaps comprises at least one retention portion in face-to-face contact with the at least one retention tab.

20. The combination of claim 19 wherein the at least one retention tab comprises two retention tabs, each retention tab abutting the outer layer of each of the first and second dispenser flaps.

21. The combination of claim 19 wherein the at least one retention portion comprises a first retention portion comprising a portion of the inner layer of the first dispenser flap and a second retention portion comprising a portion of the inner layer of the second dispenser flap.

22. The combination of claim 14, the top end flap comprising a handle flap foldably connected to the top end flap, the reinforcing end flap being adjacent to the handle flap.

23. The combination of claim 22 wherein the at least two end flaps comprise a first side end flap foldably connected to the first side panel and a second side end flap foldably connected to the second side panel, the first side end flap comprising a first handle cutout and the second side end flap comprising a second handle cutout, wherein the first and second handle cutouts and the handle flap are handle features that form a handle of the carton formed from the carton blank.

24. The combination of claim 23 wherein the top end flap, the reinforcing end flap, the first and second side end flaps, and the first and second handle cutouts are positioned so that the carton formed from the combination of the carton blank and the insert blank comprises three layers of material adjacent the handle, the three layers of material comprising at least a portion of the top end flap, the reinforcing end flap, and the first and second side end flaps.

25. The combination of claim 22 wherein the handle flap comprises a handle fold line connecting the handle flap to the top end flap, and wherein the reinforcing end flap extends from the central panel to the handle fold line.

26. A method of forming a carton comprising:
obtaining a carton blank comprising:
a plurality of panels comprising a top panel, a bottom panel, a first side panel, and a second side panel;
at least two end flaps respectively foldably attached to respective panels of the plurality of panels, the at least two end flaps comprise a top end flap foldably connected to the top panel; and
a dispenser feature comprising at least a portion of the top panel;
obtaining an insert blank comprising:
a central panel and a reinforcing end flap foldably connected to the central panel, the dispenser feature comprising at least a portion of the central panel;
positioning the insert blank relative to the carton blank so that the central panel overlaps at least a portion of the top panel and the reinforcing flap overlaps at least a portion of the top end flap;
attaching the insert blank to the carton blank; and
forming the attached insert blank and carton blank into a carton.

27. The method of claim 26 wherein the dispenser feature comprises a first tear line in the top panel and a second tear line in the central panel.

28. The method of claim 27, further comprising opening at least one dispenser flap by tearing along the first and second tear lines, the at least one dispenser flap comprising at least a portion of the top flap and at least a portion of the central panel.

29. The method of claim 28, the at least one dispenser flap comprising a first dispenser flap and a second dispenser flap, wherein opening the at least one dispenser flap further comprises pivoting the first and second dispenser flaps about respective fold lines.

30. The method of claim 28, further comprising closing the at least one dispenser flap, wherein the at least one dispenser flap comprises an inner layer having at least one retention portion and an outer layer, the top panel comprising a retention tab situated proximate to the dispenser feature, wherein the retention portion engages the retention tab to retain the at least one dispenser panel in the closed position when the at least one dispenser panel is closed.

31. The method of claim 26, further comprising activating a handle in the carton, the handle comprising a handle flap that is foldably connected to the top end flap, and the reinforcing end flap being adjacent to the handle flap.

32. The method of claim 31, the at least two end flaps further comprising a first side end flap and a second side end flap, the first side end flap comprising a first handle cutout, and the second side end flap comprising a second handle cutout, wherein forming the insert blank and the carton blank into a carton comprises overlapping the top end flap and the first and second side end flaps to form an at least partially closed end of the carton and aligning the first and second handle cutouts with the handle flap so that the handle flap is inserted into the first and second handle cutouts when the handle is activated.

33. The method of claim 32, wherein positioning the insert blank relative to the carton blank comprises placing the reinforcing flap in face-to-face contact with at least a portion of an interior surface of the top end flap, and wherein overlapping the top end flap and the first and second side end flaps comprises placing the reinforcing flap in face-to face contact with at least a portion of an exterior surface of each of the first and second side end flaps.
